(19) United States
(12) Patent Application Publication
(10) Pub. No.: US 2013/0305360 A1
(43) Pub. Date: Nov. 14, 2013

(54) DETECTING METHOD AND DEVICE

(71) Applicant: FUJITSU LIMITED, Kawasaki-shi (JP)

(72) Inventors: Takashi YOSHIOKA, Kawasaki (JP); Hiroshi Tsuda, Fujisawa (JP)

(73) Assignee: Fujitsu Limited, Kawasaki-shi (JP)

(21) Appl. No.: 13/792,422

(22) Filed: Mar. 11, 2013

(30) Foreign Application Priority Data
May 10, 2012 (JP) 2012-108458

(51) Int. Cl. H04L 29/06

(52) U.S. Cl. CPC H04L 63/1483
USPC 726/22

(57) ABSTRACT

A detecting method includes: receiving a text information mail including text information, first verification information on the text information, first verification information of attached information which is attached to the text information, and an attached information mail including the attached information, first verification information of the text information, and first verification information of the attached information from a transmission source; generating second verification information of the text information, and second verification information of the attached information, based on shared information which is shared with the transmission source, and an algorithm; and detecting a spoof, based on a comparison result of the first verification information of the text information and the second verification information of the text information, and a comparison result of the first verification information of the attached information and the second verification information of the attached information.

### CROSS-REFERENCE TO RELATED APPLICATION

This application is based upon and claims the benefit of priority from the prior Japanese Patent Application No. 2012-108458 filed on May 10, 2012, the entire contents of which are incorporated herein by reference.

### FIELD

The embodiment discussed herein is related to a method of detecting a spoof by email, a medium in which a detecting program is stored, a detecting device, a transmission terminal, and a reception terminal.

### BACKGROUND

In recent years, an attack targeting a specific company or personal computers has rapidly increased. In particular, a targeted attack using email in regards to a company, a government agency, or the like has rapidly increased. Hereinafter, email which is transmitted as the targeted attack is referred to as a targeted attack email. The targeted attack email is a virus mail which is sent to target a specified company or an organization in order to steal confidential information. A computer is infected with a virus when opening an attached file in which a spoofed code is plotted.

In antivirus software in the related art, a problematic program is registered by its signature. It is possible to suppress a virus infection by detecting a program which matches the signature. However, it does not work in an attack using a program whose signature is not registered. Further, antivirus software has already been introduced to lots of companies, however, it is not possible to completely suppress a virus infection. This is because an attached file or a text is skillfully created, and it is difficult to regard the mail as suspicious at a glance. In addition, there is a limit even if each person carefully checks a consistency of an email header, an attached file, a text, an address of a sender, or the like.

As an antivirus technology in the related art, a technology is disclosed in Japanese Laid-open Patent Publication No. 2002-041173, in which a file not authenticated on the server side is not allowed to be opened on the client side. In addition, a technology is disclosed in Japanese Laid-open Patent Publication No. 2011-008730, in which execution of a risk analysis is determined on the server side in accordance with a transmission path.

### SUMMARY

According to an aspect of the invention, a detecting method which detects a spoof by email to be executed by a computer, the detecting method includes: dividing an email to be transmitted into text information and attached information; generating first verification information using an algorithm in which shared information is used, with respect to each of the text information and the attached information; generating a text information mail in which the first verification information is added to a header of an email including the text information; generating an attached information mail in which the first verification information is added to a header of an email including the attached information; transmitting the text information mail and the attached information mail; when the text information mail and the attached information mail are received, generating second verification information using the algorithm with respect to each of the text information which is included in the text information mail and the attached information which is included in the attached information mail; comparing the first verification information which is included in the received text information mail and the received attached information mail to the second verification information; and combining the text information included in the text information mail and the attached information included in the attached information mail when the first verification information matches the second verification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a system configuration according to an embodiment.

FIG. 2 is a diagram which illustrates an email transmission terminal according to the embodiment.

FIG. 3 is a diagram which illustrates a function when transmitting an email which is executed by a mail checker according to the embodiment.

FIG. 4 is a diagram which illustrates an email reception terminal according to the embodiment.

FIG. 5 is a diagram which illustrates a function when receiving an email which is executed by a mail checker according to the embodiment.

FIG. 6 is a flowchart of a shared information generating and storing process which is performed by a mail checker of the email transmission terminal according to the embodiment.

FIG. 7 is a flowchart of a shared information generating and storing process which is performed by a mail checker of the email reception terminal according to the embodiment.

FIG. 8 is a flowchart of a mail transmission process of an email transmission terminal according to the embodiment.

FIG. 9 is a diagram which illustrates a feature amount information generation process of an email transmission terminal according to the embodiment.

FIG. 10 is a diagram which illustrates a feature amount information generating and encrypting process of the email transmission terminal according to the embodiment.

FIG. 11A is a flowchart of generating and comparing verification information of mail reception process of an email reception terminal according to the embodiment.

FIG. 11B is a flowchart of comparing reception history of the mail reception process of the email reception terminal according to the embodiment.

FIG. 12 is a diagram which illustrates a feature amount information generating process of the email reception terminal according to the embodiment.

FIG. 13 is a diagram which illustrates a feature amount information generating and encrypting process of the email reception terminal according to the embodiment.

FIG. 14 is a diagram which illustrates an example of reception history information of the email reception terminal according to the embodiment.

FIG. 15 is a diagram which illustrates an example of a combining process of text information and attached information according to the embodiment.

FIGS. 16A, 16B and 16C are diagrams which illustrate examples of verification results which are displayed on a display unit of the email reception terminal according to the embodiment.

### DESCRIPTION OF EMBODIMENT

Since a separate server may be provided for analysis and verification of a file in the related art, there is a possibility that operative costs may increase. Further, it is expected that an analysis request access to the analysis and verification server frequently occurs from numerous clients, and there is a problem in that the load of the analysis and verification server increases.

Therefore, an object of the technology which is disclosed in the embodiment is to detect a spoofed mail such as a targeted attack mail on the client basis.

Hereinafter, the embodiment will be described using drawings.

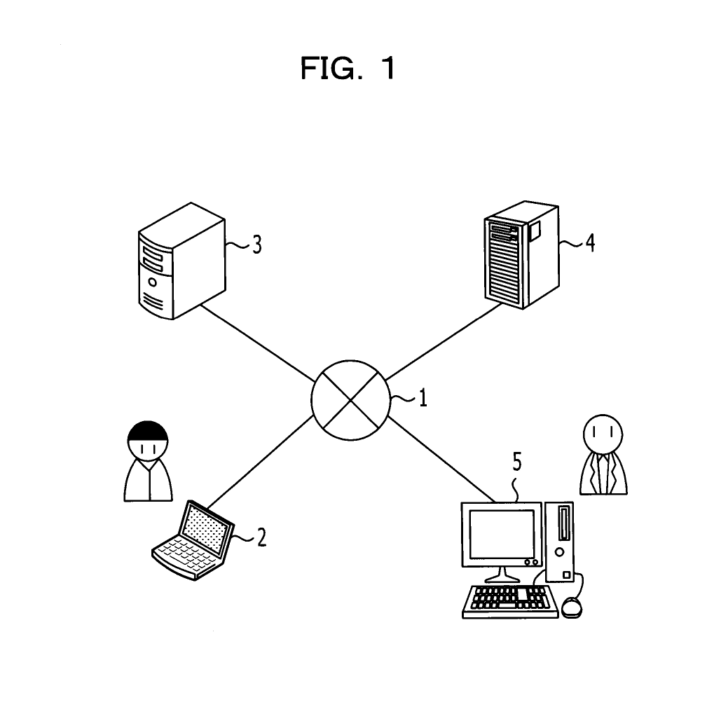

FIG. 1 is a diagram of a system configuration according to the embodiment.

In FIG. 1, a network 1 corresponds to an Intranet, or the Internet communication network. A transmission terminal 2 is used by a sender. A mail transmission server (SMTP) 3 performs transmission and reception of an email from a sender. A mail reception server (POP) 4 receives an email from a sender. A reception terminal 5 is used by a receiver.

The transmission terminal 2 and the reception terminal 5 have the same mail checker program.

The SMTP is Simple Mail Transfer Protocol, and is a protocol for transmitting email using the Internet, or the Intranet communication network. The mail transmission server (SMTP) 3 is able to transmit an email using the protocol.

The POP is Post Office Protocol, and is a protocol for receiving mail from a server which stores an email on the Internet communication network, or the Intranet. The mail server (POP) for receiving mail 4 is able to receive an email using the protocol.

Configuration of Email Transmission Terminal

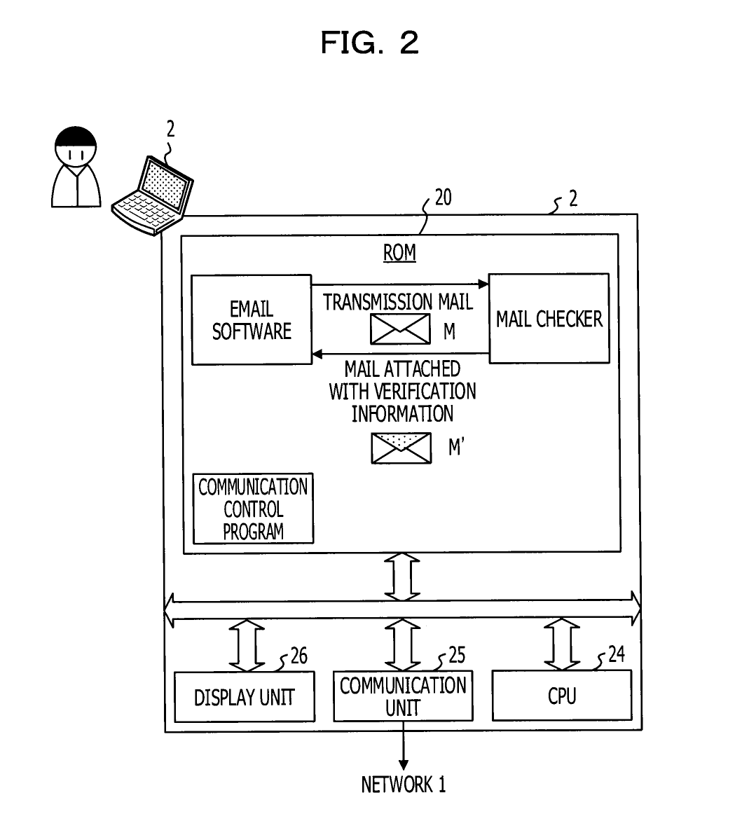

FIG. 2 is a diagram which illustrates the email transmission terminal according to the embodiment. As illustrated in FIG. 2, the transmission terminal 2 which transmits an email includes a ROM 20, a CPU 24, a communication unit 25 which is connected to the network 1, and a display unit 26 such as a liquid crystal display.

The ROM 20 stores email software by which a sender gives an instruction on creating and transmitting of an email, a mail checker which performs a generation or the like of verification information as information for confirming whether or not the email is a spoofed mail, and various programs such as a communication control program or the like for transmitting an email through the network 1. The email software corresponds to, for example, mailer such as Outlook® by Microsoft, Corporation or Thunderbird® by the Mozilla Foundation.

The CPU 24 executes various programs which are stored in the ROM 20, and controls the transmission terminal 2.

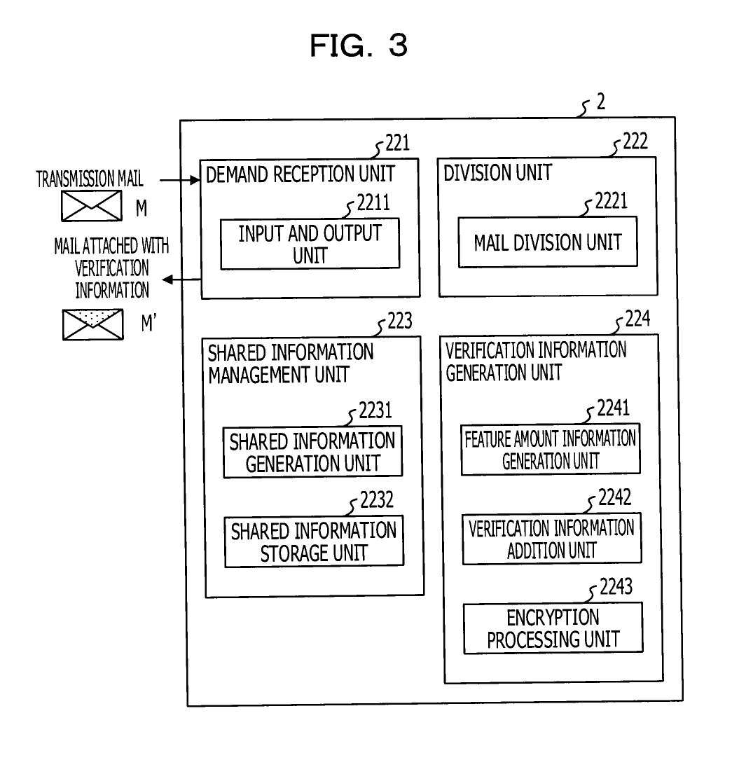

FIG. 3 is a diagram which illustrates a function which is executed by the mail checker according to the embodiment when transmitting an email. As illustrated in FIG. 3, the transmission terminal 2 includes a demand reception unit 221, a division unit 222, a shared information management unit 223, and a verification information generation unit 224.

The demand reception unit 221 includes an input and output unit 2211. The demand reception unit 221 receives a demand of generation process request of verification information, and returns a processed result. The division unit 222 includes a mail division unit 2221. The division unit 222 divides an email into text information and attached information. The shared information management unit 223 includes a shared information generation unit 2231 and a shared information storage unit 2232. The shared information management unit 223 treats shared information which is used when generating the verification information. The verification information generation unit 224 includes a feature amount information generation unit 2241, a verification information addition unit 2242, and an encryption processing unit 2243. The verification information generation unit 224 generates and adds verification information. In addition, operation contents of each unit will be described later.

Configuration of Email Reception Terminal

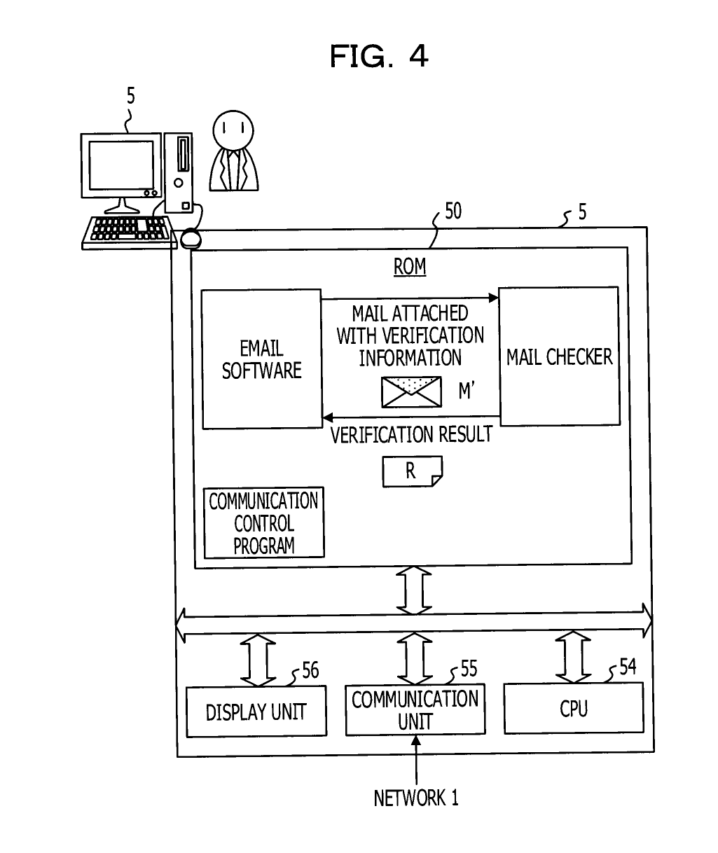

FIG. 4 is a diagram which illustrates the email reception terminal according to the embodiment. As illustrated in FIG. 4, the reception terminal 5 which receives an email includes a ROM 50, a CPU 54, a communication unit 55 which is connected to the network 1, and a display unit 56 which is a liquid crystal display, or the like.

The ROM 50 stores email software by which a receiver gives an instruction of receiving an email, a mail checker which performs verification of “verification information”, and various programs such as a communication control program or the like for transmitting an email through the network 1. Here, the mail checker is the same program which is included in the ROM 20 of the transmission terminal 2. In addition, the email software corresponds to, for example, mailer such as Outlook® by Microsoft Corporation, or Thunderbird® by the Mozilla Foundation, similarly to the transmission terminal 2.

The CPU 54 executes the various programs which are stored in the ROM 50, and controls the reception terminal 5.

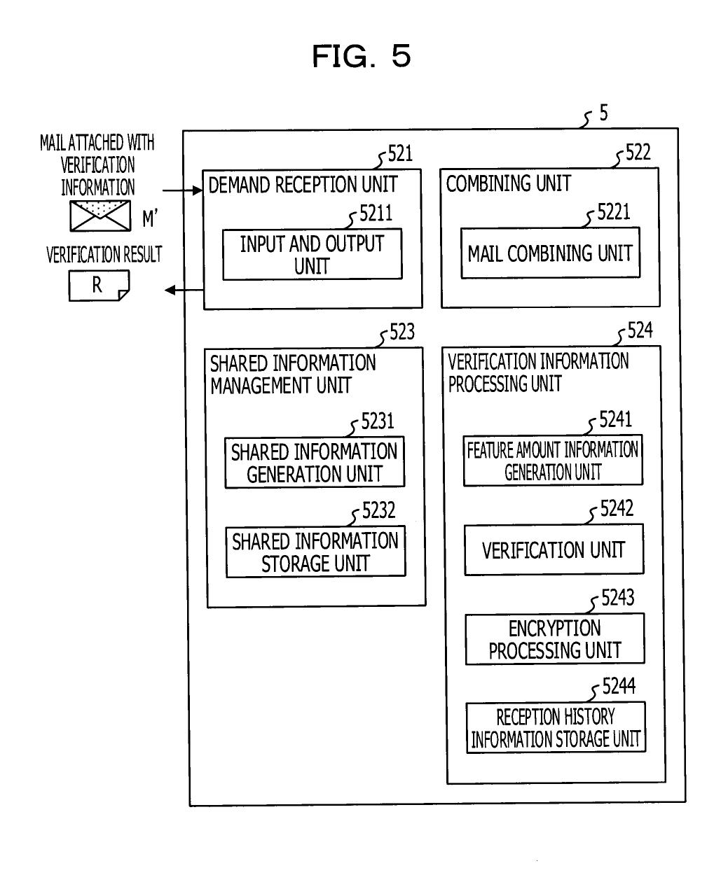

FIG. 5 is a diagram which illustrates a function which is executed by the mail checker according to the embodiment when receiving an email. The reception terminal 5 includes a demand reception unit 521, a combining unit 522, a shared information management unit 523, and a verification processing unit 524.

The demand reception unit 521 includes an input and output unit 5211. The demand reception unit 521 receives a demand of a verification process request of verification information, and returns a processed result. The combining unit 522 includes a mail combining unit 5221. The combining unit 522 combines an email which is divided into text information and attached information. The shared information management unit 523 includes a shared information generation unit 5231 and a shared information storage unit 5232. The shared information management unit 523 generates and manages shared information which is used when performing decryption of verification information. The verification processing unit 524 includes a feature amount information generation unit 5241, a verification unit 5242, an encryption processing unit 5243, and a reception history information storage unit 5244. The verification processing unit 524 generates and verifies verification information from the text information, or the attached information. In addition, operation contents of each unit will be described later.

Spoofed Mail Detecting Process

Regarding a targeted attack mail detecting process using a system which is configured as described above, the processing operation will be described as follows.

A summary of the spoofed mail detecting process will be described, before describing a flow of a specific spoofed mail detecting process.

First, the transmission terminal 2 shares shared information with the reception terminal 5 in advance (hereinafter, referred to as shared information generating and storing process). As will be described later, the shared information is information which is used for generating verification information in each of the transmission terminal 2 and reception terminal 5, and is configured using a certain character strings, for example. In addition, the verification information is information which is used for determining whether or not an email which is received in the reception terminal 5 is a spoofed mail. As described later, according to the embodiment, since a determination on a spoofed mail is performed based on verification information in the reception terminal 5, the shared information is kept in secret between the transmission terminal 2 and reception terminal 5 so that an attacker is unable to illegitimately generate the verification information.

Subsequently, the transmission terminal 2 creates a transmission mail by executing the email software. The transmission terminal 2 executes the mail checker with respect to the created transmission mail. The transmission terminal 2 creates an email attached with verification information by generating verification information using a certain algorithm in which shared information is used. In addition, the transmission terminal 2 transmits an email to which verification information is attached by executing the email software (hereinafter, referred to as mail transmission processing).

On the other hand, the reception terminal 5 receives an email attached with verification information by executing the email software. The reception terminal 5 executes the mail checker with respect to the email attached with verification information. The reception terminal 5 generates verification information using the same algorithm as that in the transmission terminal 2. In addition, the reception terminal 5 detects a spoofed mail by comparing verification information which is included in the email with verification information attached, that is, verification information which is generated in the transmission terminal 2 to verify information which is generated in the reception terminal 5. When the verification information generated in the transmission terminal 2 does not match the verification information generated in the reception terminal 5, it is determined that the received email attached with verification information may be a spoofed mail (hereinafter, referred to as mail reception process).

In this manner, the spoofed mail detecting process includes shared information generating and storing process, a mail transmitting process, and a mail receiving process.

Shared Information Generating and Storing Process

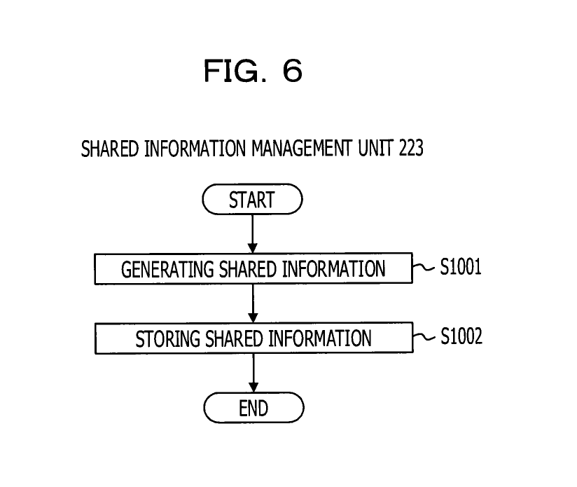

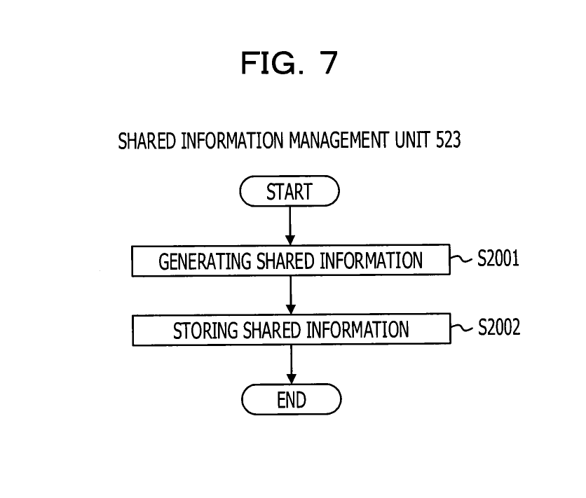

FIG. 6 is a flowchart of the shared information generating and storing process using the email transmission terminal according to the embodiment. FIG. 7 is a flowchart of the shared information generating and storing process using the email reception terminal according to the embodiment.

In the transmission terminal 2, the shared information management unit 223 generates shared information (S1001). The shared information management unit 223 stores the shared information through the shared information storage unit 2232 (S1002). At this time, the generated shared information is safely stored so as not to be leaked out to the outside.

On the other hand, in the reception terminal 5, the shared information management unit 523 generates shared information using the same algorithm as that in the shared information generating process (S1001) of the transmission terminal 2 (S2001). The shared information management unit 523 stores the shared information through the shared information storage unit 5232 (S2002). At this time, the generated shared information is safely stored so as not to be leaked out to the outside.

In this manner, when the transmission terminal 2 and the reception terminal 5 store the same shared information which is kept between the two, an attacker is not able to create spoofed verification information since it is not possible to know the shared information.

Mail Transmitting Process

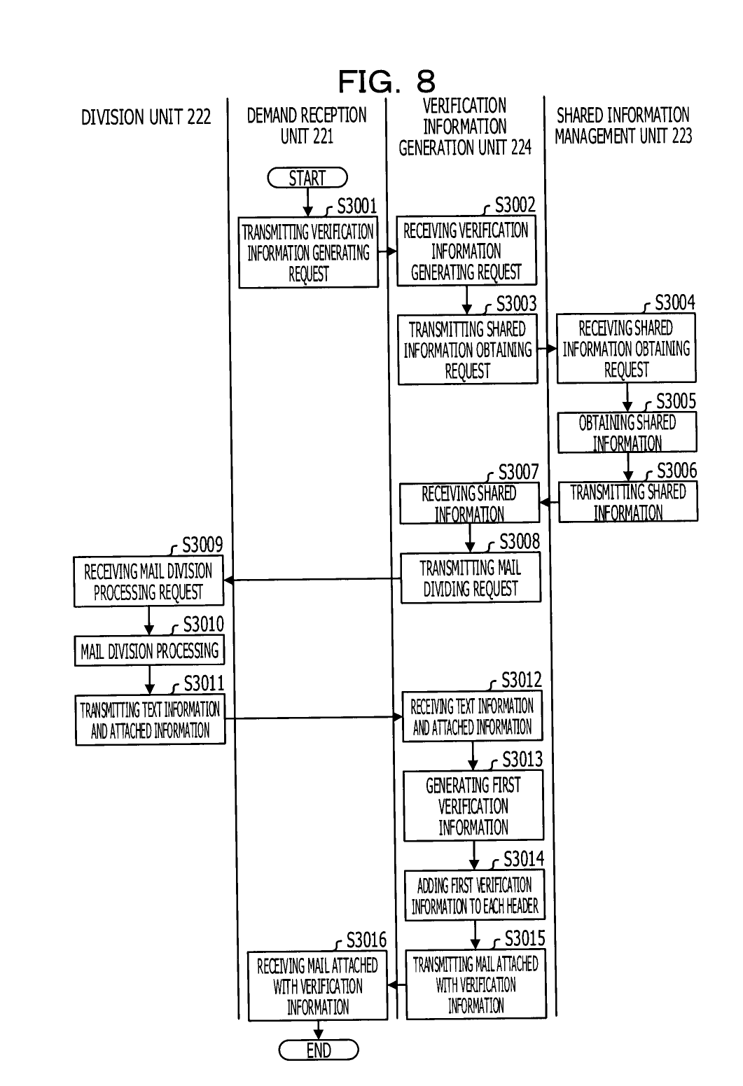

FIG. 8 is a flowchart of the mail transmitting process of the email transmission terminal according to the embodiment.

First, the transmission terminal 2 executes the email software, and creates a transmission mail before starting a process in FIG. 8. After creating the transmission mail, the email software transmits the transmission mail including mail header information, text information and attached information to the mail checker, and further issues a request for creating verification information.

Here, the text information corresponds to the message text of the transmission mail, and also includes link information such as uniform resource locator (URL) which is described in the text. Mail header information is information about the sender and address, a subject, a date or the like. In addition, the attached information corresponds to, for example, link information such as a URL which is included in a message text of a transmission mail, electronic file information which is separately prepared from the text information. As for the electronic file information, there is a DOC file which is created using Microsoft Word®, a PDF file which is created using Adobe Acrobat®, an EXE file as a program executable format, a compressed Zip file, and the like.

The demand reception unit 221 receives a request of generating verification information along with the transmission mail including text information with header information, and the attached information from the email software through the input and output unit 2211. In addition, the demand reception unit 221 transmits the request for generating verification information to the verification information generation unit 224 (S3001).

The verification information generation unit 224 receives the request for generating verification information (S3002). The verification information generation unit 224 transmits a request for obtaining shared information to the shared information management unit 223 (S3003).

The shared information management unit 223 receives the request for obtaining shared information (S3004). In addition, the shared information management unit 223 obtains shared information from the shared information storage unit 2232 (S3005). In addition, the shared information management unit 223 transmits the shared information to the verification information generation unit 224 (S3006).

After step S3006, the verification information generation unit 224 receives the shared information from the shared information management unit 223 (53007). The verification information generation unit 224 transmits a mail division request to the division unit 222 (S3008).

The division unit 222 receives the mail division request (S3009). The division unit 222 divides the transmission mail which is received by the demand reception unit 221 through the mail division unit 2221 into text information and attached information (S3010). For example, when link information is described in a message body of the transmission mail, and electronic file information is attached thereto, the transmission mail is divided into three pieces of information of the text information corresponding to the message body of the transmission mail, attached link information corresponding to the link information which is described in the message body, and attached file information corresponding to the electronic file information which is attached to the transmission mail due to a process in step S3010. In the text information, the attached link information, and the attached file information, respective source codes or the like may be used. In addition, when the link information is not described in the message body of the transmission mail, and the electronic file information is attached thereto, the transmission mail is divided into two pieces of information of text information and attached information due to a process in step S3010. After the process in step S3010, the division unit 222 transmits the divided text information and attached file information to the verification information generation unit 224 (S3011).

The verification information generation unit 224 receives the text information and attached information (S3012). The verification information generation unit 224 generates verification information (hereinafter, referred to as first verification information) using a certain algorithm in which the shared information is used with respect to the respective text information and attached information (S3013). A specific example of a method of generating the verification information will be described later.

After generating the first verification information, the verification information generation unit 224 generates a text information mail in which a first verification information of text information, and a first verification information of attached information are added to an email header of the text information, through the verification information addition unit 2242. In addition, the verification information generation unit 224 generates an attached information mail by similarly adding the first verification information of text information, and the first verification information of attached information to an email header of the attached information, as well (S3014). In addition, the verification information generation unit 224 transmits the text information mail and the attached information mail to the demand reception unit 221 (S3015).

The demand reception unit 221 receives the text information mail and the attached information mail (S3016). The demand reception unit 221 outputs the received text information mail and attached information mail to the email software. The transmission terminal 2 executes the email software, and transmits the text information mail and the attached information mail to the reception terminal 5 through the transmission mail (SMTP) server 3.

Example of verification information generated in mail transmitting process

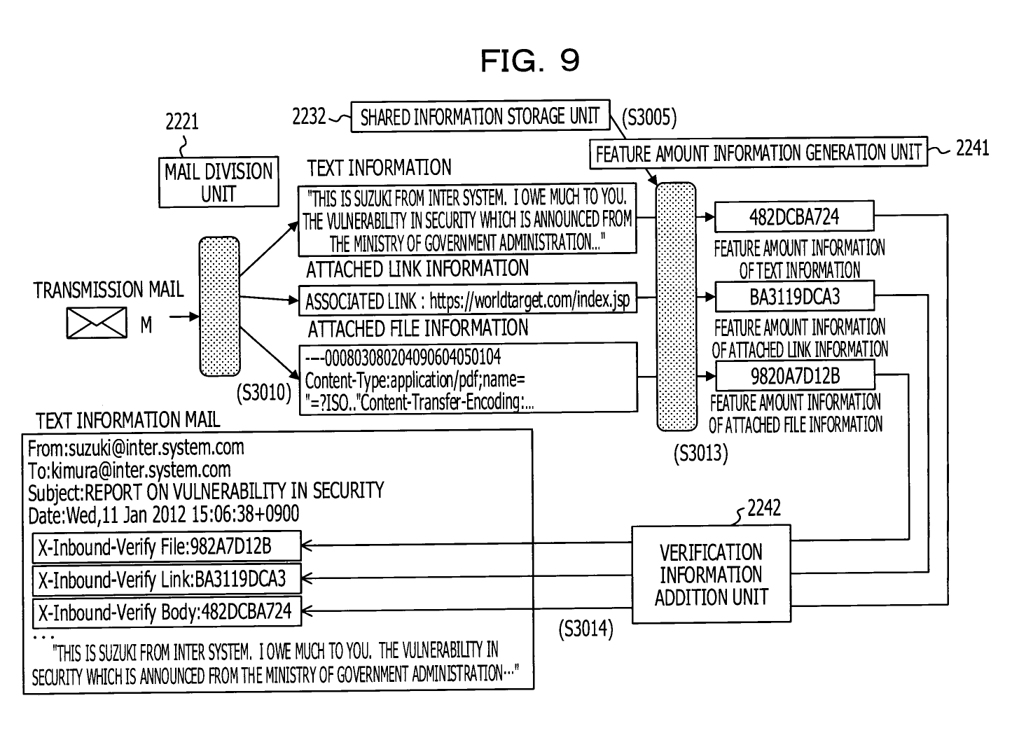

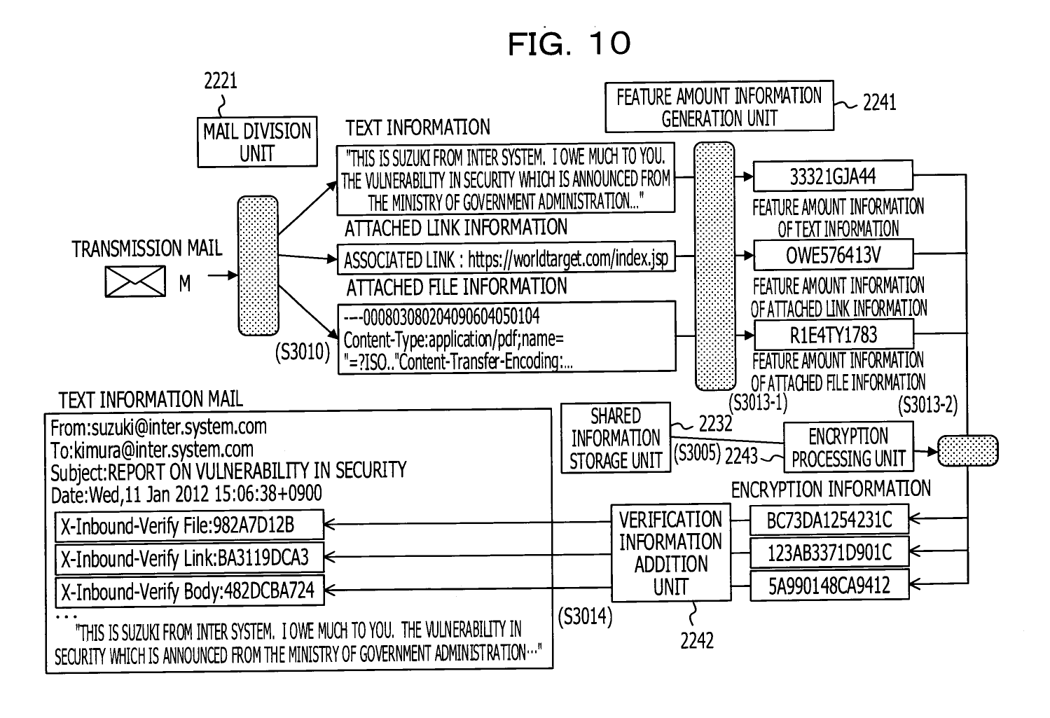

Here, a specific example of the first verification information which is generated in the mail transmitting process will be described using FIGS. 9 and 10. FIG. 9 is a diagram which illustrates the feature amount information generating process of the email transmission terminal according to the embodiment. FIG. 10 is a diagram which illustrates the feature amount information generating and encrypting process of the email transmission terminal according to the embodiment.

FIG. 9 illustrates an example in which feature amount information which is generated using shared information with respect to the respective text information and attached information is used as the first verification information.

Specifically, first, text information, attached link information, and attached file information are generated using the mail division unit 2221 in step S3010. In addition, the feature amount generation unit 2241 of the verification information generation unit 224 adds shared information to the top, or the end of the respective information of the text information, the attached link information, and the attached file information, and generates the first feature amount information using a feature amount generation algorithm (first algorithm) (S3013).

The first feature amount information is hash information, for example, which is generated using a one-way hash function. In addition, a feature amount generation algorithm other than the one-way hash information may be used. However, as described later, in order to secure consistency of the first feature amount information at the time of the mail receiving process, the feature amount information generation unit 2241 of the verification information generation unit 224 shares the feature amount information generation algorithm with the feature amount information generation unit 5241 of the reception terminal 5.

As a result of the process in step S3013, “482DCBA724” as the first feature amount information of the text information, “BA3119DCA3” as the first feature amount information of the attached link information, and “9820A7D12B” as the first feature amount information of the attached file information are generated.

After generating the first feature amount information (S3013), the three pieces of first feature amount information generated in step S3013 are added as the first verification information with respect to the respective email header of the text information, attached link information, and attached file information. That is, each of text information mail, attached link information mail and attached file information mail to which the first verification information is added to each header is generated (S3014).

In FIG. 9, as a specific example of step S3014, the three pieces of first verification information are added to the header of the email of the text information. That is, “X-Inbound-VerifyFile: first feature amount information of attached file information”, “X-Inbound-VerifyLink: first feature amount information of attached link information”, and “X-Inbound-VerifyBody: first feature amount information of text information” are attached to the email header of the text information in order, and the text information mail is generated.

On the other hand, FIG. 10 illustrates an example in which encrypted information in which respective pieces of feature amount information of the text information and the attached information are encrypted using shared information is used as the first verification information.

Specifically, first, a transmission mail is divided into the text information, attached link information, and attached file information using the mail division unit 2221 (S3010). In addition, the feature amount information generation unit 2241 generates the first feature amount information using the above described feature amount generation algorithm with respect to the text information, attached link information, and attached file information (S3013-1). As a result in step S3013-1, “33321GJA44” as the first feature amount information of the text information, “QWE576413V” as the first feature amount information of the attached link information, and “R1E4TY1783” as the first feature amount information of the attached file information are generated.

Subsequently, the encryption processing unit 2243 generates a first encryption information by encrypting each of the first feature amount information using an encryption algorithm (second algorithm) in which shared information which is obtained in step S3005 is used as a key (S3013-2). In this manner, “BC73DA1254231C” as the first encryption information of the text information, “123AB3371D901C” as the first encryption information of the attached link information, and “5A990148CA9412” as the first encryption information of the attached file information are generated.

In the verification information addition unit 2242, with respect to the respective email header of the text information, the attached link information, and the attached file information, the three pieces of first encryption information are added as the first verification information. That is, each of the text information mail, attached link information mail, and attached file information mail to which the first verification information is added is generated (S3014).

In FIG. 10, as a specific example, the three pieces of first verification information are added to the email of the text information. That is, “X-Inbound-VerifyFile: first encryption information of attached file information”, “X-Inbound-VerifyLink: first encryption information of attached link information”, and “X-Inbound-VerifyBody: first encryption information of text information” are added to the email header of the text information in order, and the text information mail is generated.

In this manner, the transmission terminal 2 generates the first feature amount information in FIG. 9, or the first feature amount information in FIG. 10 as the first verification information using the algorithm in which the shared information is used. In addition, the transmission terminal 2 transmits a text information mail in which the first verification information is added to the text information email, and an attached information mail in which the first verification information is added to the attached information email to the reception terminal 5.

Mail receiving process (verification information generating and comparing process)

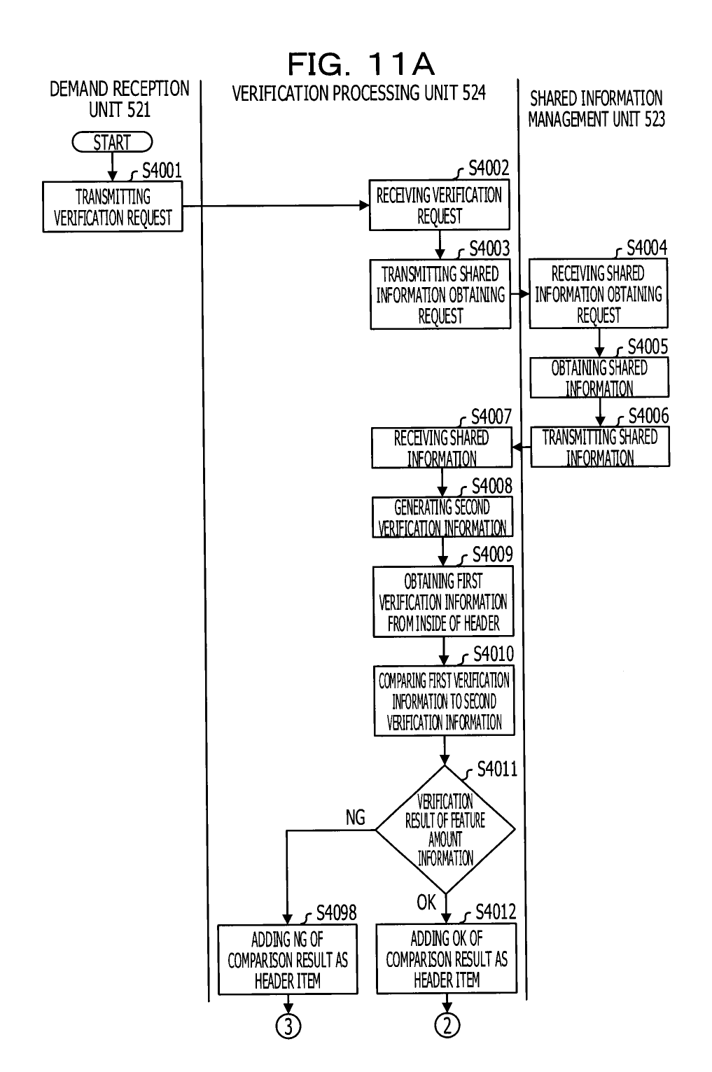

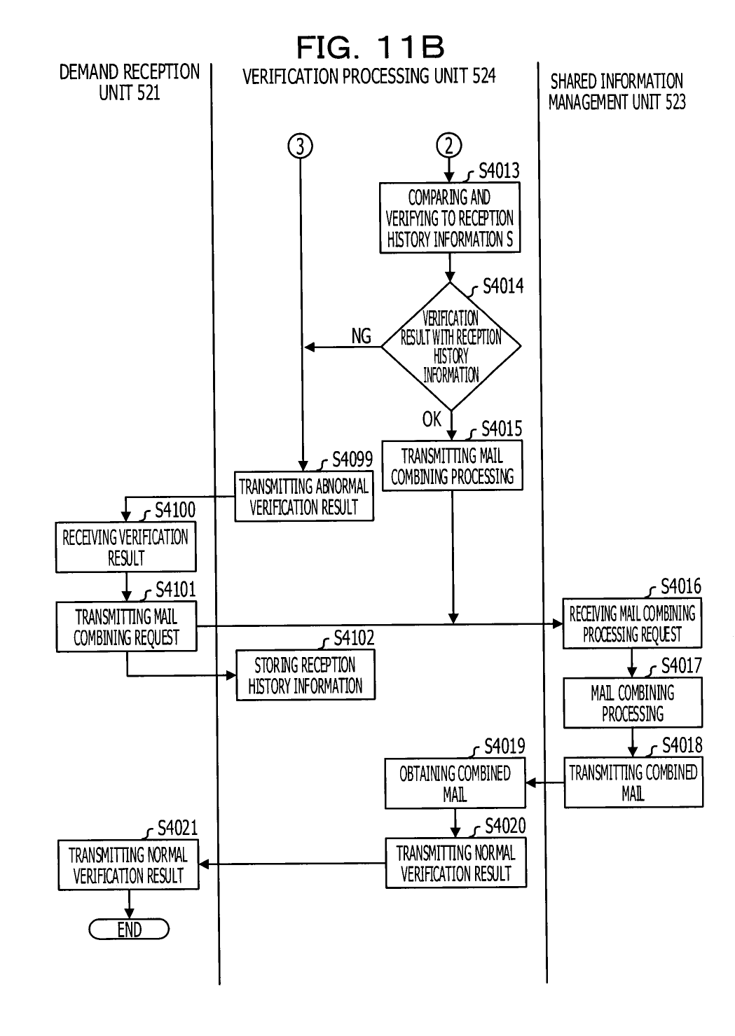

FIGS. 11A and 11B are flowcharts of processes using the reception terminal 5. FIG. 11A is a flowchart of generating and comparing the verification information in the mail receiving process in the email reception terminal 5 according to the embodiment.

The reception terminal 5 executes the email software, and receives the text information mail and attached information mail through the mail reception server (POP) 4. In addition, the email software transmits the received text information mail and attached information mail to the mail checker, and further issues a request for verification.

The demand reception unit 521 receives the received text information mail, attached information mail, and the verification request from the email software through the input and output units 5211. In addition, the demand reception unit 521 transmits the request for verification with respect to the verification processing unit 524 (S4001).

The verification processing unit 524 receives a verification request (S4002). The verification processing unit 524 transmits a shared information obtaining request to the shared information management unit 523 (S4003).

The shared information management unit 523 receives the shared information obtaining request (S4004). In addition, the shared information management unit 523 obtains shared information from the shared information storage unit 5231 (S4005). The shared information management unit 523 transmits the shared information to the verification processing unit 524 (S4006).

The verification processing unit 524 receives the shared information from the shared information management unit 523 (S4007). The verification processing unit 524 generates verification information (hereinafter, referred to as second verification information) using the same algorithm as that in step S3013 of the mail transmitting process which is performed in the transmission terminal 2 with respect to the respective text information of the text information mail, and the attached information of the attached information mail (S4008).

Subsequently, the verification processing unit 524 obtains the first verification information of the text information, and the first verification information of the attached information from a mail header of the text information. Similarly, the verification processing unit 524 obtains the first verification information of the text information, and the first verification information of the attached information from a mail header of the attached information (S4009).

The verification processing unit 524 compares each of the first verification information which is obtained in step S4009 with respect to each of the text information mail, and the attached information mail to each of the second verification information which is generated in step S4008 (S4010). The verification processing unit 524 determines whether or not the first verification information matches the second verification information (S4011).

The reception terminal 5 shares the received text information and attached information with the transmission terminal 2. In addition, the reception terminal 5 generates the second verification information with the same algorithm using the shared information which is kept secret to the outside. For this reason, when an email is normally transmitted from the transmission terminal 2, the second verification information matches the first verification information (OK in step S4011). However, when there is even just one piece of first verification information which does not match the second verification information (NG in step S4011) in the determination result, there is a possibility that the email having the first verification information which does not match the second verification information among the received text information mail and attached information mail is a spoofed mail. For example, it may be a case in which a third person sends a spoofed mail under the semblance of a sender of the transmission terminal 2, or a third person falsifies an email on the way of transmitting the email. Therefore, the verification processing unit 524 adds the determination result in step S4011 to each header of the received text information mail and attached information mail so as to be able to distinguish the spoofed mail from the received email (S4012, S4098).

Specific example of mail receiving process (verification information generating and comparing process)

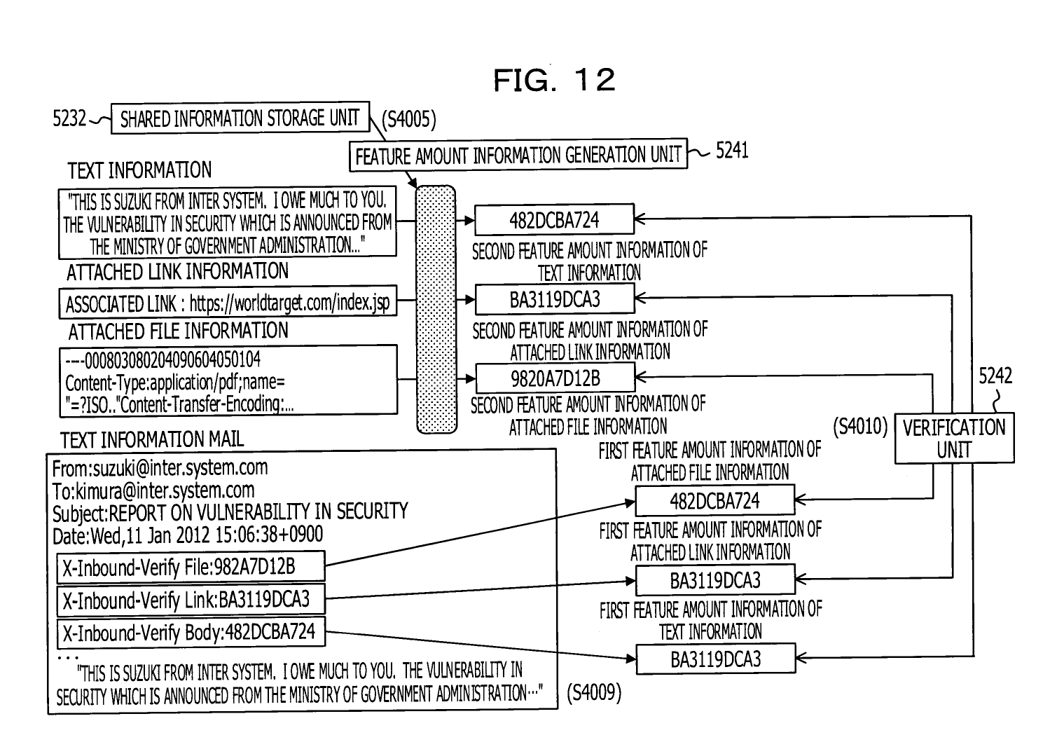

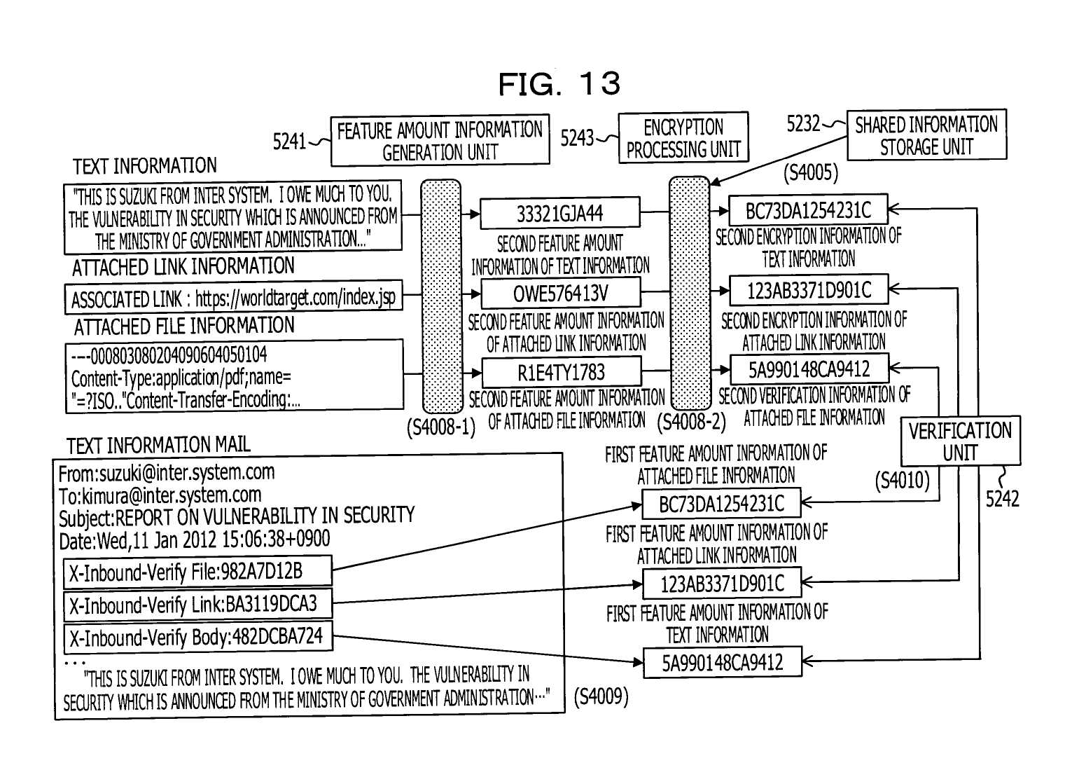

Here, a specific example of the second verification information which is generated in the mail receiving process will be described using FIGS. 12 and 13. FIG. 12 is a diagram which illustrates a feature amount information generating process of the email reception terminal according to the embodiment. FIG. 13 is a diagram which illustrates a feature amount information generating and encrypting process of the email reception terminal according to the embodiment.

FIG. 12 illustrates the feature amount information generating process in the reception terminal 5 which is performed corresponding to FIG. 9 which is described above.

Specifically, first, the feature amount information generation unit 2241 of the verification information generation unit 224 obtains text information, attached link information, and attached file information from the text information mail, the attached link information mail, and the attached file information mail which are received in the demand reception unit 521.

In addition, the feature amount information generation unit 2241 generates a second feature amount information using the same feature amount generating algorithm as that in the transmission terminal 2 in FIG. 9, by adding shared information to the top, or the end of the respective information of the text information, the attached link information, and the attached file information (S4008).

As a result of the process in step S4008, “482DCBA724” as the second feature amount information of the text information, “BA3119DCA3” as the second feature amount information of the attached link information, and “9820A7D12B” as the second feature amount information of the attached file information are generated.

After generating the second feature amount information (S4008), the verification unit 5242 obtains the first feature amount information from each header of the text information mail, the attached link information mail, and the attached file information mail (S4009). The verification unit 5242 compares the first feature amount information to the second feature amount information (S4010).

In FIG. 12, “9820A7D12B” as the first feature amount information of the attached file information, “BA3119DCA3” as the first feature amount information of the attached link information, and “482DCBA724” as the first feature amount information of the text information are obtained from the header of the text information mail. In addition, since each of the first feature amount information matches the corresponding second feature amount information (OK in S4011), a comparison result “X-Inbound-Verify:OK” is added to the header of the text information mail. In addition, as a result of step S4010, when even just one piece of first verification information which does not match the second verification information is present (NG in S4011), “X-Inbound-Verify:NG” is added.

The steps S4009 and S4010 are also performed with respect to the attached link information mail, and the attached file information mail, similarly to the text information mail and a comparison result is added to the respective headers.

On the other hand, FIG. 13 illustrates the feature amount information generating and encrypting process in the reception terminal 5 which is performed corresponding to FIG. 10 which is described above.

Specifically, first, the feature amount information generation unit 2241 of the verification information generation unit 224 obtains text information, attached link information, and attached file information from the text information mail, the attached link information mail, and the attached file information mail which are received in the demand reception unit 521.

In addition, the feature amount information generating unit 5241 generates the second feature amount information using the same feature amount generating algorithm as that in the transmission terminal 2 in FIG. 10 with respect to the text information, the attached link information, and the attached file information (S4008-1). In FIG. 13, as a result in step S4008-1, “33321GJA44” as the second feature amount information of the text information, “QWE576413V” as the second feature amount information of the attached link information, and “R1E4TY1783” as the second feature amount information of the attached file information are generated.

Subsequently, the encryption processing unit 5243 generates a second encryption information by encrypting each of the second feature amount information using an encryption algorithm (second algorithm) in which shared information which is obtained in step S4005 is used as a key (S3013-2). In this manner, “BC73DA1254231C” as the second encryption information of the text information, “123AB3371D901C” as the second encryption information of the attached link information, and “5A990148CA9412” as the second encryption information of the attached file information are generated.

The verification unit 5242 obtains the first encryption information from each of the text information mail, the attached link information mail, and the attached file information mail (S4009), and compares the first encryption information to the second encryption information (S4010). In FIG. 13, “BC73DA1254231C” as the first encryption information of the attached file information, “123AB3371D901C” as the first encryption information of the attached link information, and “482DCBA724” as the first encryption information of the text information are obtained. In addition, since each of the first encryption information matches the corresponding second encryption information (OK in step S4011), the comparison result “X-Inbound-Verify:OK” is added to the header of the text information mail. In addition, as a result in step S4010, even when just one piece of the first verification information does not match the second verification information (NG in step S4011), “X-Inbound-Verify:NG” is added.

In this manner, the reception terminal 5 generates the second verification information with respect to the respective received text information and attached information. In addition, the reception terminal 5 compares the pieces of the first verification information of the received text information mail and attached information mail to the generated second verification information. In this manner, the reception terminal 5 is able to determine whether or not the received email is a spoofed mail.

Mail Receiving Process (Reception History Comparison Process)

FIG. 11B is a flowchart of a reception history comparison process of a mail receiving process of the email reception terminal according to the embodiment.

As illustrated in FIG. 12, when even just one piece of first verification information does not match the second verification information in step S4011 (NG in step S4011), the verification processing unit 524 adds a comparison result denoting that the verification is NG to each of the headers of the text information mail and the attached information mail (S4098). In addition, the verification processing unit 524 transmits the abnormal verification result to the demand reception unit 521 (S4099).

On the other hand, when each of the first verification information matches the corresponding second verification information (OK in S4011), the verification unit 5242 of the verification processing unit 524 adds the comparison result denoting that the verification is OK to the header (S4012). In addition, the verification unit 5242 compares the text information mail and the attached information mail to the reception history information of a reception history information storage unit 5244 (S4013). The verification unit 5242 determines whether or not there is a possibility of a spoofed mail (S4014).

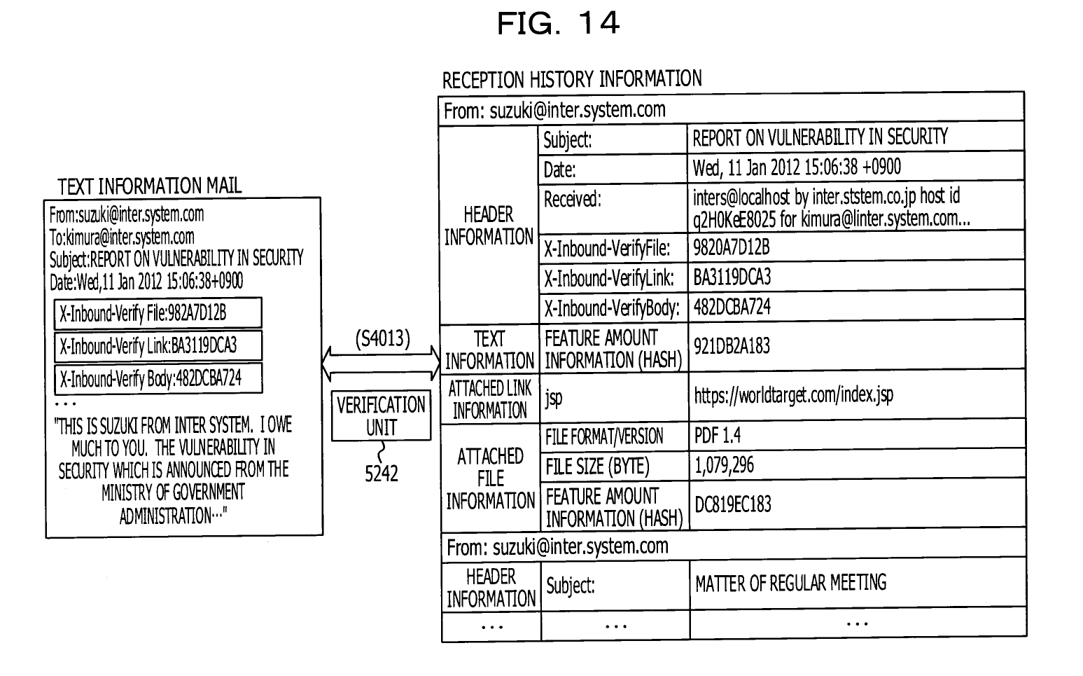

Herein FIG. 14 is a diagram which illustrates an example of the reception history information of the email reception terminal according to the embodiment. As illustrated in FIG. 14, the reception history information is a record of a mail which is not a spoofed mail and which is normally received, up to the present, by the reception terminal 5. The reception history information manages the header information, the text information, the attached information, or the like, including the first verification information for each sender. That is, when the received text information mail and the attached information mail match the reception history information, each received email is determined not to be a spoofed mail.

In step S4013, first, the verification unit 5242 of the verification processing unit 524 confirms whether or not a sender of the received text information mail and the attached information mail is present in the reception history information.

When the sender is not present in the reception history information (NG in S4014), since there is a possibility that the received email is a spoofed mail, the abnormal verification result is transmitted to the demand reception unit 521 (S4099).

When the sender is present in the reception history information, the verification unit 5242 confirms whether or not a history in which all of the first verification information of the received text information, the first verification information of the attached link information, and the first verification information of the attached file information match is present in the reception history information.

When there is not a matching history (NG in S4014), since there is a possibility that the received email is a spoofed mail, the abnormal verification result is transmitted to the demand reception unit 521 (S4099).

When there is a matching history, there is a high possibility that the received email is a mail that has been received in the past. However, there is a possibility that a third person who knows the algorithm generating the first verification information may create a spoofed mail so that the first verification information matches the reception history information. Therefore, the verification unit 5242 compares the received text information, attached link information and attached file information to the history with respect to received managing items of the received history information. For example, the verification unit 5242 compares a hash value in which the text information is converted using a hash function, link information of the attached link information, and a file size of the attached file information to one another.

In addition, when even only one item of which content does not match is present in each of the control items (NG in S4014), since there is a possibility that the received email is a spoofed mail, the abnormal verification result is transmitted to the demand reception unit 521 (S4099).

When all of the contents in each of the control items match (OK in S4014), the received email is a mail which has been received in the past, and is determined not to be a spoofed mail. The verification processing unit 524 transmits a request of mail combining process to the combining unit 522 (S4015).

On the other hand, the demand reception unit 521 receives the abnormal verification result which is transmitted in step S4099 (S4100). When the demand reception unit 521 transmits the verification result to the email software, a receiver who operates the reception terminal 5 is informed of the abnormal verification result through a display device 54.

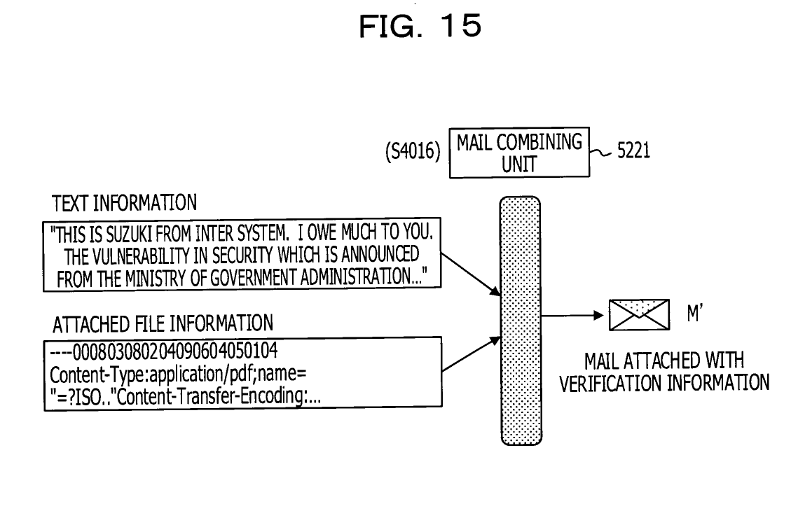

The receiver performs a counteraction or the like of checking the sender based on the abnormal verification result. When it is determined that the email which is received by the receiver is not a spoofed mail, the request of mail combining process is transmitted to the demand reception unit 521 through the email software. The demand reception unit 521 which receives the request of mail combining process transmits the request of mail combining process to the combining unit 522 (S4101). In addition, the verification processing unit 524 stores the received email through the reception history information storage unit 5244 (S4102). The combining unit 522 receives a mail combining processing request (S4016). The text information and the attached information are combined through the mail combining unit 5221 (S4017). The combining unit 522 transmits the combined reception mail to the verification processing unit 524 (S4018). A specific example of a combining process in step S4017 will be illustrated in FIG. 15.

FIG. 15 is a diagram which illustrates an example of the combining process of the text information and the attached information according to the embodiment. In FIG. 15, on the premise of the combining process, the reception terminal 5 receives the text information mail, the attached link information, and the attached file information from the transmission terminal 2. In addition, in step S4014, it is determined that each mail is not a spoofed mail. As described above, according to the embodiment, the text information of the text information mail includes link information such as a URL which is included in the attached link information. For this reason, in FIG. 15, the mail combining unit 5221 of the combining unit 522 obtains the text information and the attached file information from the text information mail and the attached file information. In addition, the mail combining unit 5221 generates a received mail in which verification information is added to a header by combining the text information and the attached file information (S4017).

Returning to FIG. 11B, the verification processing unit 524 obtains a received mail which is combined (S4019). The verification processing unit 524 transmits the received mail which has been combined to the demand reception unit 521 along with a normal verification result (S4020). The demand reception unit 521 receives the verification result (S4021). The demand reception unit 521 transmits the verification result to the email software. The receiver who operates the reception terminal 5 is informed of the verification result through the display device 54.

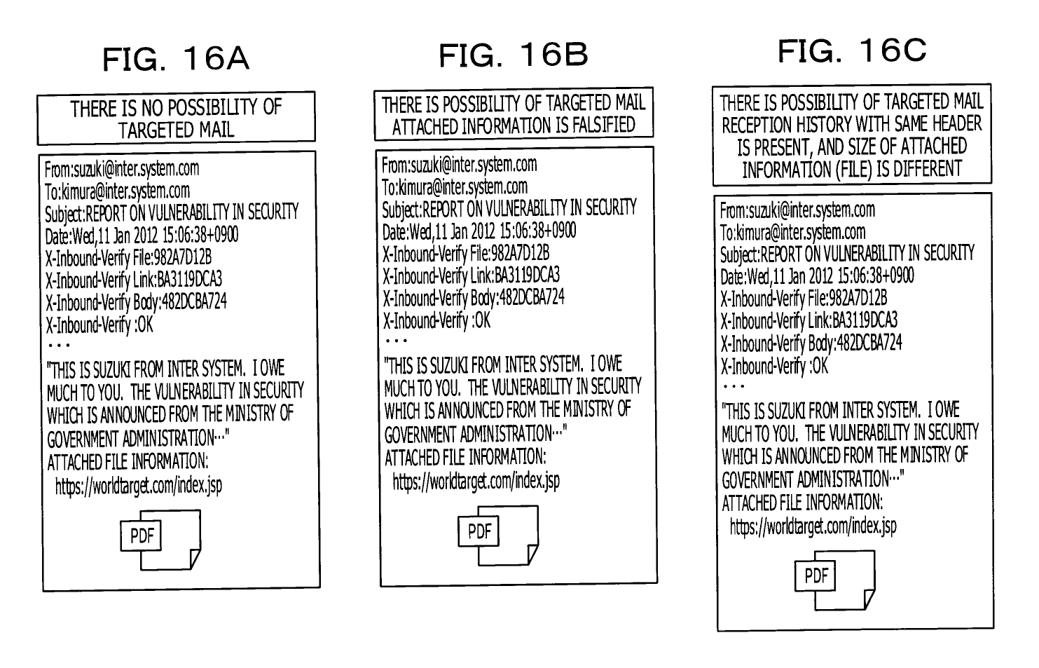

FIG. 16 is a diagram which illustrates an example of a verification result which is displayed on the display unit of the email reception terminal according to the embodiment. Specific examples of informing a receiver of verification results which are displayed, and the text information mails are illustrated in FIGS. 16A, 16B, and 16C.

FIG. 16A is a display example of a verification result when a received mail is determined not to be a spoofed mail (OK in S4014), since the received mail is a mail which has been received in the past in step S4014. That is, it is a case in which a history of receiving the email having the same first verification information is present in the reception history information, and the received email matches the history in control items of the reception history information.

FIG. 16B is a display example of a verification result when determining that there is a possibility that a received mail is a spoofed mail in step 54011 (NG in S4011). That is, it is a case in which at least one of the pieces of first verification information which are added to the respective header of the text information mail, attached link information mail, and attached file information mail does not match the corresponding second verification information.

FIG. 16C is a display example of a verification result when determining that there is a possibility that a received mail is a spoofed mail (NG in S4014) in step S4014. For example, it is a case in which a history in which all of the respective first verification information of the received text information, attached link information, and attached file information match is present in the reception history information, however, a size of the attached file information is different.

In this manner, by displaying and informing a receiver as in FIGS. 16B and 16C, the receiver who operates the reception terminal 5 is able to confirm that there is a possibility that the received email is a spoofed mail. Accordingly, the receiver can react by not opening the attached file.

As described above, according to the embodiment, it is possible to detect a spoofed mail on the client base when the transmission terminal 2 and reception terminal 5 have the same mail checker program.

Specifically, according to the embodiment, the text information mail and the attached information mail are transmitted and received. The first verification information for determining a spoofed mail is added to the respective header of the text information mail and attached information mail by the transmission terminal 2. The first verification information is information which is generated using a certain algorithm in which secret shared information is used. In this manner, it is difficult for a third person to create a spoofed mail since it is not able to analyze shared information or an algorithm in each of the text information mail and attached information mail.

In addition, the reception terminal 5 compares the first verification information of the received text information mail and attached information mail to the second verification information which is generated using the same algorithm as that in the transmission terminal 2 regarding the received text information mail and attached information mail. In this manner, it is possible for the reception terminal 5 to determine whether or not the received text information mail and attached information mail are spoofed mails, and a receiver who operates the reception terminal 5 does not open the spoofed mails.

In addition, even when the first verification information matches the second verification information regardless of receiving a spoofed mail by the reception terminal 5, the reception terminal 5 is able to detect the spoofed mail by comparing the received text information mail and attached information mail to the reception history information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A detecting method which detects a spoofed email to be executed by a computer, the detecting method comprising:
dividing an email to be transmitted into text information and attached information;
generating first verification information using an algorithm in which shared information is used, with respect to each of the text information and the attached information;
generating a text information mail in which the first verification information is added to a header of an email including the text information;
generating an attached information mail in which the first verification information is added to a header of an email including the attached information;
transmitting the text information mail and the attached information mail;
when the text information mail and the attached information mail are received, generating second verification information using the algorithm with respect to each of the text information which is included in the text information mail and the attached information which is included in the attached information mail;
comparing the first verification information which is included in the received text information mail and the received attached information mail to the second verification information; and
combining the text information included in the text information mail and the attached information included in the attached information mail when the first verification information matches the second verification information.

2. The detecting method according to claim 1,
wherein the first verification information is first feature amount information which is generated based on the respective text information to which the shared information is added, and attached information to which the shared information is added, and the algorithm, and
wherein the second verification information is second feature amount information which is generated based on the respective text information to which the shared information is added, and attached information to which the shared information is added, and the algorithm.

3. The detecting method according to claim 2,
wherein the comparing compares the first feature amount information to the second feature amount information with respect to each of the text information and the attached information.

4. The detecting method according to claim 1,
wherein the first verification information is first encryption information which is generated based on first feature amount information which is generated using a first algorithm with respect to each of the text information and the attached information, and a second algorithm which is encrypted using the shared information, and
wherein the second verification information is second encryption information which is generated based on second feature amount information which is generated using the first algorithm with respect to each of the text information and the attached information, and the second algorithm.

5. The detecting method according to claim 1,
wherein the attached information is one of attached link information relating to link information which is attached to the email and attached file information relating to file data, or both the attached link information and the attached file information.

6. The detecting method according to claim 5,
wherein the combining, when the first verification information matches the second verification information, combines the text information and the attached information.

7. The detecting method according to claim 1,
wherein the generating of the text information mail adds the first verification information, with respect to each of the text information and the attached information, to the header of the email, and
wherein the generating of the attached information mail adds the first verification information, with respect to each of the text information and the attached information, to the header of the email.

8. The detecting method according to claim 1,
wherein the algorithm is a one-way hash function.

9. The detecting method according to claim 1,
wherein the comparing, when the first verification information matches the second verification information, adds the comparison result to the respective headers of the text information mail and the attached information mail.

10. The detecting method according to claim 1, further comprising:
comparing the first verification information included in the text information mail and the attached information mail to the first verification information in reception history information when the first verification information matches the second verification information.

11. A computer-readable recording medium storing a program for causing a computer to execute a procedure for detecting a spoofed email, the procedure comprising:
dividing an email to be transmitted into text information and attached information;
generating first verification information using an algorithm in which shared information is used with respect to each of the text information and the attached information;
generating a text information mail in which the first verification information is added to a header of an email including the text information;
generating an attached information mail in which the first verification information is added to a header of an email including the attached information;
transmitting the text information mail and the attached information mail;
when the text information mail and the attached information mail are received, generating second verification information using the algorithm with respect to each of the text information which is included in the text information mail and the attached information which is included in the attached information mail;
comparing the first verification information which is included in the received text information mail and the received attached information mail to the second verification information; and
combining the text information included in the text information mail and the attached information included in the attached information mail when the first verification information matches the second verification information.

12. A detecting device which detects a spoofed email, comprising:
a memory configured to store a program including a procedure; and
a processor configured to execute the program, the procedure including:
dividing an email to be transmitted into text information and attached information;
generating first verification information using an algorithm in which shared information is used with respect to each of the text information and the attached information;
generating a text information mail in which the first verification information is added to a header of an email including the text information;
generating an attached information mail in which the first verification information is added to a header of an email including the attached information;
transmitting the text information mail and the attached information mail;
when the text information mail and the attached information mail are received, generating second verification information using the algorithm with respect to each of the text information which is included in the text information mail and the attached information which is included in the attached information mail;
comparing the first verification information which is included in the received text information mail and the received attached information mail to the second verification information; and
combining the text information included in the text information mail and the attached information included in the attached information mail when the first verification information matches the second verification information.

13. A transmission terminal comprising:
a memory configured to store a program including a procedure; and
a processor configured to execute the program, the procedure including:
obtaining text information and attached information of a transmission target;
generating verification information of the text information and the verification information of the attached information based on shared information which is shared with a transmission destination and an algorithm;
generating a text information mail including the text information, verification information of the text information, and verification information of the attached information;
generating an attached information mail including the attached information, verification information of the text information, verification information of the attached information; and
transmitting the text information mail and the attached information mail to the transmission destination.

14. A reception terminal comprising:
a memory configured to store a program including a procedure; and
a processor configured to execute the program, the procedure including:
receiving a text information mail including text information, first verification information on the text information, first verification information of attached information which is attached to the text information, and an attached information mail including the attached information, first verification information of the text information, and first verification information of the attached information from a transmission source;
generating second verification information of the text information, and second verification information of the attached information, based on shared information which is shared with the transmission source, and an algorithm; and
detecting a possibility of a spoof, based on a comparison result of the first verification information of the text information and the second verification information of the text information, and a comparison result of the first verification information of the attached information and the second verification information of the attached information.
